(19) United States
(12) Patent Application Publication
(10) Pub. No.: US 2021/0012444 A1
(43) Pub. Date: Jan. 14, 2021

(54) AUTOMATED PATENT PREPARATION

(71) Applicant: Michael Carey, Boulder, CO (US)

(72) Inventor: Michael Carey, Boulder, CO (US)

(21) Appl. No.: 16/506,543

(22) Filed: Jul. 9, 2019

(51) Int. Cl. G06Q 50/18; G06F 17/22; G06F 17/24; G06F 17/27

(52) U.S. Cl. CPC G06Q 50/184; G06F 17/278; G06F 17/24; G06F 17/2247

(57) ABSTRACT

Systems and methods are described for computer based patent preparation. The systems and methods may provide for identifying a set of invention features, generating a first tree structure, wherein one or more nodes of the first tree structure correspond to a first subset of the set of invention features, generating a second tree structure, wherein one or more nodes of the second tree structure correspond to a second subset of the set of invention features, and automatically generating one or more patent application documents based at least in part on the first tree structure and the second tree structure.

### BACKGROUND

The following relates generally to patent preparation, and more specifically to computer based patent preparation.

Patent preparation is often performed by patent attorneys or agents who draft documents that are then submitted to the United States Patent and Trademark Office (USPTO). In some cases, the labor involved in preparing may involve the expenditure of a significant amount of time and may cost a significant amount of money. In some cases, the costs associated with patent preparation may inhibit inventors from patenting and benefitting from useful inventions.

### SUMMARY

A method, apparatus, non-transitory computer readable medium, and system for computer based patent preparation are described. The method, apparatus, non-transitory computer readable medium, and system may provide for identifying a set of invention features, generating a first tree structure, wherein one or more nodes of the first tree structure correspond to a first subset of the set of invention features, generating a second tree structure, wherein one or more nodes of the second tree structure correspond to a second subset of the set of invention features, and automatically generating one or more patent application documents based at least in part on the first tree structure and the second tree structure.

### BRIEF DESCRIPTION OF THE DRAWINGS

FIG. 1 shows an example of a patent preparation system in accordance with aspects of the present disclosure.

FIG. 2 shows an example of a computer system in accordance with aspects of the present disclosure.

FIGS. 3 through 5 show examples of a process for computer based patent preparation in accordance with aspects of the present disclosure.

### DETAILED DESCRIPTION

Methods, systems, and devices for automated patent preparation are described. A patent preparation system may facilitate efficient preparation of patent documents by identifying user input that includes an association of patent features (e.g., claims) with the components of a system that performs those features. The input may also include aspects of patent figures, acronyms, and other aspects of a patent disclosure. The user input may be used to create an application data object, which may then be used to create components of a patent including patent specification components and patent figures such as diagrams and flow charts. The generated components may be combined with templates to generate patent documents.

According to embodiments of the present disclosure, the inventive features (or other details providing context or elements for a patent disclosure) may be represented as a list of features. One or more tree structures may be generated that correspond to the same list of features. For example, one or more data objects may represent different ways of organizing the information of a patent disclosure (i.e., into claims, figures, or an outline of topics). Thus, the structure of the application may be stored separately from the content of the application.

By receiving input in the form of an application data object and generating a specification data object (and, in some cases, a drawings data object), the system may store patent application information more efficiently (e.g., only a limited set of application inputs may be stored as opposed to a document that includes template information, boilerplate, and many repetitions of the same data) and avoid unnecessary repetition of certain patent drafting tasks. For example, the application data object may include an association of each claim element to a system component. A lookup function may then associate the system component with each of the associated. Thus, when generating a description of each figure that contains that component, an automated function can be applied to a list of features or elements associated with the component, thereby automatically providing structural support for a method claim, and support in the specification for claim elements.

Similarly, flowcharts may be automatically generated from claims and, since the claim elements have component associations, language may be automatically generated that states which system components perform each step of a flowchart, and automatically generate connecting language associating steps of a flowchart to descriptions of a diagram representing an apparatus including the relevant system components.

Also, figure numbering and written description numbering may be made consistent in an automated way by generating a list of components for each figure, assigning each component in the list a number (e.g., with a systematic algorithm such as adding 5 or 10 to the last component number) and doing a replace function on mentions of that component in a figure description. In some cases, automatic numbering insertion may utilize dynamic references instead of static numbers so that if figures or components are added in a word processing application such as Microsoft Word, the numbers are encoded with information that allows the word processing application to automatically renumber the figure components (i.e., using bookmarks and reference fields in the numbering elements that are inserted by the find and replace function).

In some examples, the system may utilize exceptions to prevent insertion of component numbers in undesired locations. For example, if one component is called component A and a second component is called component AB, the first component would be a substring of the second component, Thus, the system may create an exception such that it does not replace the string ‘component A’ in the with the component number for component A in the string component AB. In one embodiment this may be done using regular expressions to search for component names but exclude other ‘including’ component names.

In some cases, the system generates one extensible markup language (XML) objects corresponding to text or fields to be inserted into a template. The system may then decompress a template, identify the document XML, and insert the generated XML components into the document XML. The document XML may then be recompressed along with other files associated with the document to create a draft specification (or, as the case may be, the drawings). This may enable separate template and boilerplate information to be stored separately from the application inputs and may facilitate an automated process for generating patent document content and combining the generated application specific content with content from a template or library.

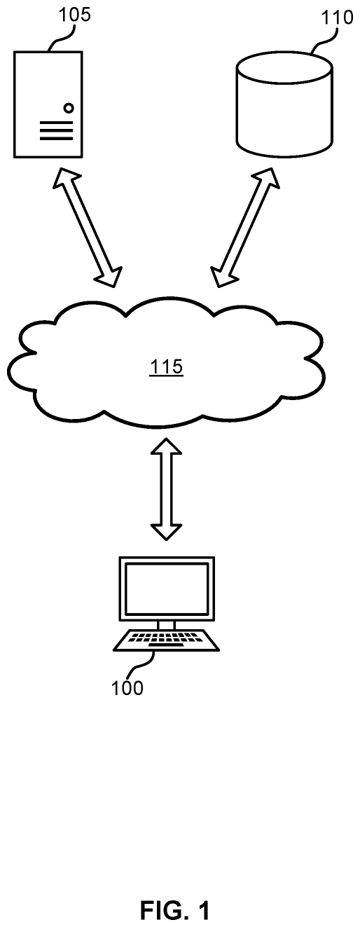

FIG. 1 shows an example of a patent preparation system in accordance with aspects of the present disclosure. The example shown includes terminal 100, server 105, database 110, and network 115. A user may provide inputs for a patent via terminal 100. The terminal 100 and server may then perform the automated patent preparation steps described herein by communicating with each other (and with a database 110) via network 115. In some cases, the content and data structures representing the invention may be saved or stored in databased 110. In some cases, documents (i.e., a text document of drawings document) may be generated at server 105 and downloaded to terminal 100 based on a request from a user of terminal 100.

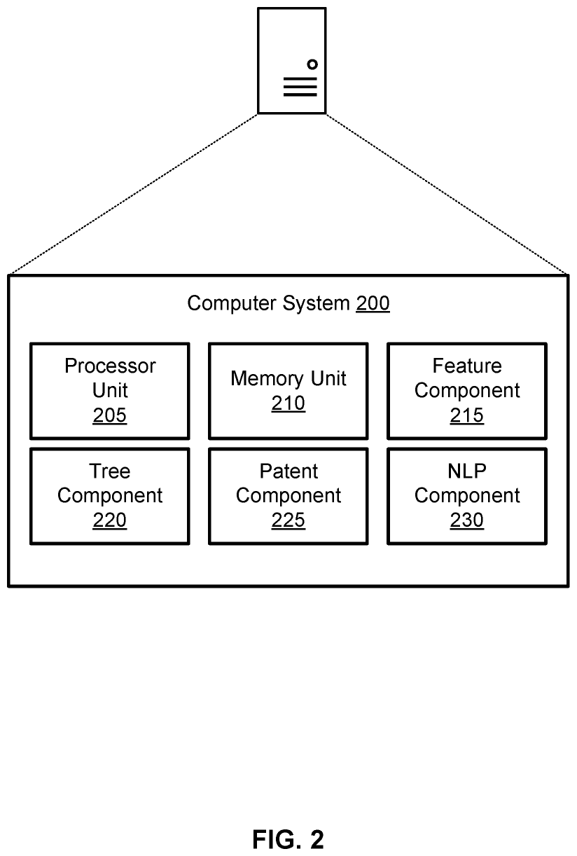

FIG. 2 shows an example of a computer system 200 in accordance with aspects of the present disclosure. Computer system 200 may correspond to the server 105, the terminal 100, or a combination of both. That is, in some cases the functions described herein may be performed on a user terminal and in other cases they may be performed on a server (or using a serverless architecture), and in some cases the functions are distributed between a user terminal and a server (or serverless computing system).

A processor unit 205 may include an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, the processor may be configured to operate a memory array using a memory controller. In other cases, a memory controller may be integrated into processor. The processor may be configured to execute computer-readable instructions stored in a memory to perform various functions.

A memory unit 210 may store information for various programs and applications on a computing device. For example, the storage may include data for running an operating system. The memory may include both volatile memory and non-volatile memory. Volatile memory may random access memory (RAM), and non-volatile memory may include read-only memory (ROM), flash memory, electrically erasable programmable read-only memory (EEPROM), digital tape, a hard disk drive (HDD), and a solid state drive (SSD). Memory may include any combination of readable and/or writable volatile memories and/or non-volatile memories, along with other possible storage devices.

Computer system 200 may include processor unit 205, memory unit 210, feature component 215, tree component 220, patent component 225, and NLP component 230.

Feature component 215 may identify a set of invention features. Feature component 215 may also import a claim set, where the set of invention features is identified based on the imported claim set.

Tree component 220 may generate a first tree structure, where one or more nodes of the first tree structure correspond to a first subset of the set of invention features. Tree component 220 may also generate a second tree structure, where one or more nodes of the second tree structure correspond to a second subset of the set of invention features. In some examples, each invention feature in the first subset includes an attribute identifying a node of the one or more nodes of the first tree, and each invention feature in the second subset includes an attribute identifying a node of the one or more nodes of the second tree. In some examples, at least a portion of the second tree structure is automatically generated based on the first tree structure. In some examples, the first tree structure includes a topic hierarchy and the second tree structure includes a claim hierarchy. Tree component 220 may also generate at least a portion of the second tree structure by assigning sibling nodes of the topic hierarchy as sibling features of a claim, and by assigning a dependency of the claim based on a parent node of the sibling nodes. In some examples, the first tree structure includes a claim hierarchy and the second tree structure includes a figure hierarchy. In some examples, at least one figure node of the figure hierarchy includes a flowchart corresponding to a claim of the claim hierarchy, and where each feature of the claim corresponds to a step in the flowchart. In some examples, each feature of a parent claim in the claim hierarchy corresponds to a step in the flowchart. In some examples, the set of invention features are represented as an array object, and where the first tree structure and the second tree structure are represented as non-array objects.

Patent component 225 may automatically generate one or more patent application documents based on the first tree structure and the second tree structure.

NLP component 230 may perform a first natural language processing function on a feature of the set of invention features based on a correspondence with the first tree structure. NLP component 230 may also perform a second natural language processing function on the feature based on a correspondence with the second tree structure.

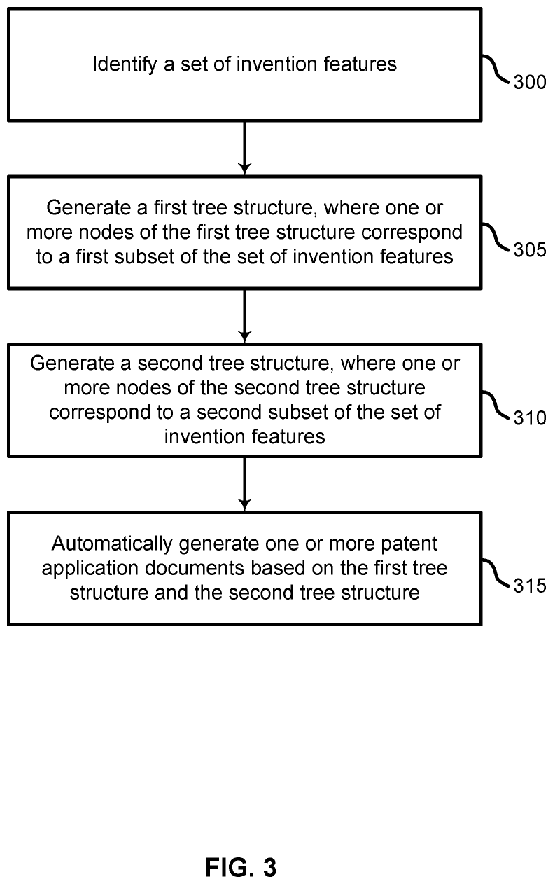

FIG. 3 shows an example of a process for computer based patent preparation in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 300, the system identifies a set of invention features. In some cases, the operations of this step may refer to, or be performed by, a as described with reference to.

At step 305, the system generates a first tree structure, where one or more nodes of the first tree structure correspond to a first subset of the set of invention features. In some cases, the operations of this step may refer to, or be performed by, a as described with reference to.

At step 310, the system generates a second tree structure, where one or more nodes of the second tree structure correspond to a second subset of the set of invention features. In some cases, the operations of this step may refer to, or be performed by, a as described with reference to.

At step 315, the system automatically generates one or more patent application documents based on the first tree structure and the second tree structure. In some cases, the operations of this step may refer to, or be performed by, a as described with reference to.

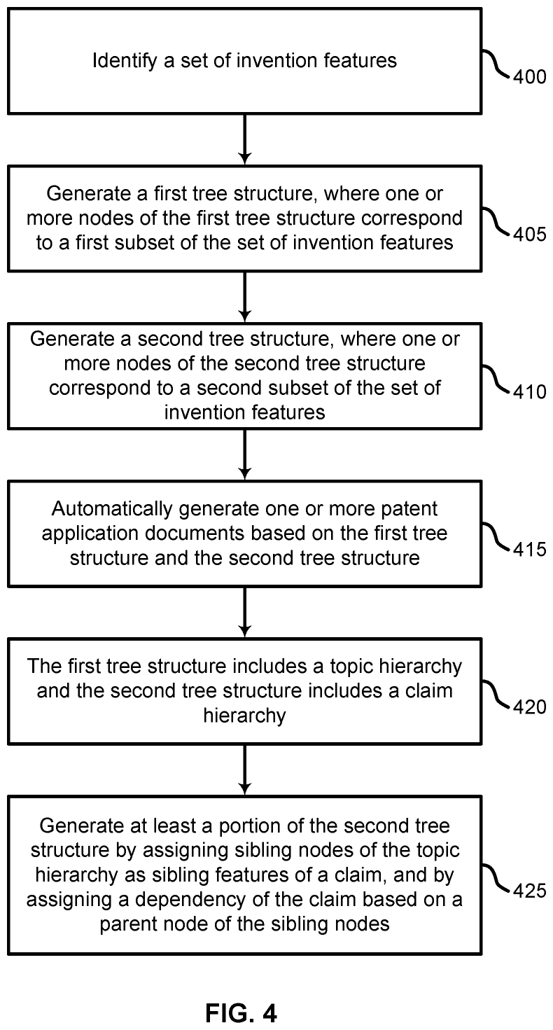

FIG. 4 shows an example of a process for computer based patent preparation in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 400, the system identifies a set of invention features. In some cases, the operations of this step may refer to, or be performed by, a as described with reference to.

At step 405, the system generates a first tree structure, where one or more nodes of the first tree structure correspond to a first subset of the set of invention features. In some cases, the operations of this step may refer to, or be performed by, a as described with reference to.

At step 410, the system generates a second tree structure, where one or more nodes of the second tree structure correspond to a second subset of the set of invention features. In some cases, the operations of this step may refer to, or be performed by, a as described with reference to.

At step 415, the system automatically generates one or more patent application documents based on the first tree structure and the second tree structure. In some cases, the operations of this step may refer to, or be performed by, a as described with reference to.

At step 420, the system the first tree structure includes a topic hierarchy and the second tree structure includes a claim hierarchy. In some cases, the operations of this step may refer to, or be performed by, a as described with reference to.

At step 425, the system generates at least a portion of the second tree structure by assigning sibling nodes of the topic hierarchy as sibling features of a claim, and by assigning a dependency of the claim based on a parent node of the sibling nodes. In some cases, the operations of this step may refer to, or be performed by, a as described with reference to.

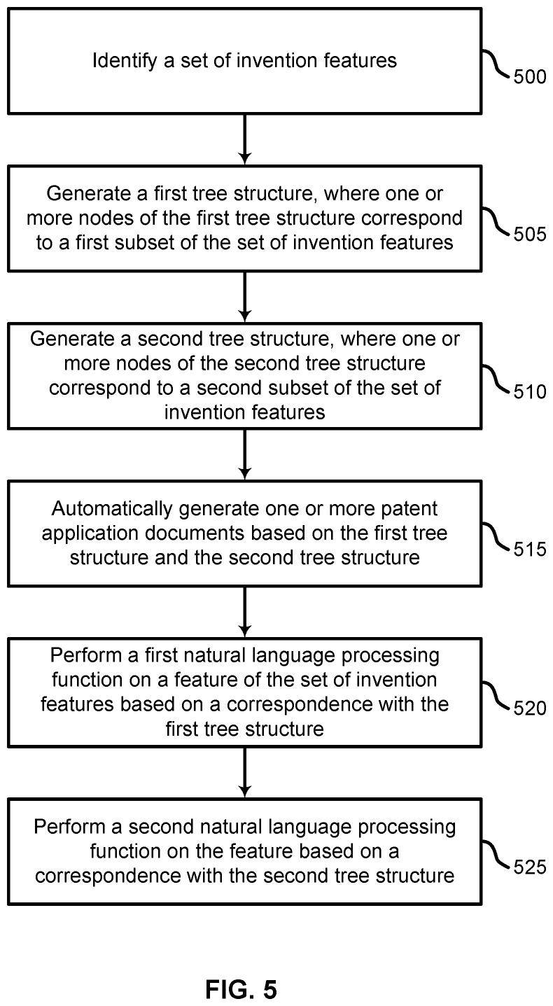

FIG. 5 shows an example of a process for computer based patent preparation in accordance with aspects of the present disclosure. In some examples, these operations may be performed by a system including a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, the system identifies a set of invention features. In some cases, the operations of this step may refer to, or be performed by, a as described with reference to.

At step 505, the system generates a first tree structure, where one or more nodes of the first tree structure correspond to a first subset of the set of invention features. In some cases, the operations of this step may refer to, or be performed by, a as described with reference to.

At step 510, the system generates a second tree structure, where one or more nodes of the second tree structure correspond to a second subset of the set of invention features. In some cases, the operations of this step may refer to, or be performed by, a as described with reference to.

At step 515, the system automatically generates one or more patent application documents based on the first tree structure and the second tree structure. In some cases, the operations of this step may refer to, or be performed by, a as described with reference to.

At step 520, the system performs a first natural language processing function on a feature of the set of invention features based on a correspondence with the first tree structure. In some cases, the operations of this step may refer to, or be performed by, a as described with reference to.

At step 525, the system performs a second natural language processing function on the feature based on a correspondence with the second tree structure. In some cases, the operations of this step may refer to, or be performed by, a as described with reference to.

Accordingly, the present disclosure includes the following embodiments.

A method for computer based patent preparation is described. The method may include identifying a set of invention features, generating a first tree structure, wherein one or more nodes of the first tree structure correspond to a first subset of the set of invention features, generating a second tree structure, wherein one or more nodes of the second tree structure correspond to a second subset of the set of invention features, and automatically generating one or more patent application documents based at least in part on the first tree structure and the second tree structure.

An apparatus for computer based patent preparation is described. The apparatus may include a processor, memory in electronic communication with the processor, and instructions stored in the memory. The instructions may be operable to cause the processor to identify a set of invention features, generate a first tree structure, wherein one or more nodes of the first tree structure correspond to a first subset of the set of invention features, generate a second tree structure, wherein one or more nodes of the second tree structure correspond to a second subset of the set of invention features, and automatically generate one or more patent application documents based at least in part on the first tree structure and the second tree structure.

A non-transitory computer readable medium storing code for computer based patent preparation is described. In some examples, the code comprises instructions executable by a processor to: identify a set of invention features, generate a first tree structure, wherein one or more nodes of the first tree structure correspond to a first subset of the set of invention features, generate a second tree structure, wherein one or more nodes of the second tree structure correspond to a second subset of the set of invention features, and automatically generate one or more patent application documents based at least in part on the first tree structure and the second tree structure.

A system for computer based patent preparation is described. The system may include means for identifying a set of invention features, means for generating a first tree structure, wherein one or more nodes of the first tree structure correspond to a first subset of the set of invention features, means for generating a second tree structure, wherein one or more nodes of the second tree structure correspond to a second subset of the set of invention features, and means for automatically generating one or more patent application documents based at least in part on the first tree structure and the second tree structure.

In some examples, each invention feature in the first subset comprises an attribute identifying a node of the one or more nodes of the first tree, and each invention feature in the second subset comprises an attribute identifying a node of the one or more nodes of the second tree.

In some examples, at least a portion of the second tree structure is automatically generated based on the first tree structure.

In some examples, the first tree structure comprises a topic hierarchy and the second tree structure comprises a claim hierarchy.

Some examples of the method, apparatus, non-transitory computer readable medium, and system described above may further include generating at least a portion of the second tree structure by assigning sibling nodes of the topic hierarchy as sibling features of a claim, and by assigning a dependency of the claim based on a parent node of the sibling nodes.

In some examples, the first tree structure comprises a claim hierarchy and the second tree structure comprises a figure hierarchy.

In some examples, at least one figure node of the figure hierarchy comprises a flowchart corresponding to a claim of the claim hierarchy, and wherein each feature of the claim corresponds to a step in the flowchart.

In some examples, each feature of a parent claim in the claim hierarchy corresponds to a step in the flowchart.

Some examples of the method, apparatus, non-transitory computer readable medium, and system described above may further include performing a first natural language processing function on a feature of the set of invention features based on a correspondence with the first tree structure. Some examples may further include performing a second natural language processing function on the feature based on a correspondence with the second tree structure.

In some examples, the set of invention features are represented as an array object, and wherein the first tree structure and the second tree structure are represented as non-array objects.

Some examples of the method, apparatus, non-transitory computer readable medium, and system described above may further include importing a claim set, wherein the set of invention features is identified based on the imported claim set.

A patent preparation system may facilitate efficient preparation of patent documents by identifying user input that includes an association of patent features (e.g., claims) with the components of a system that performs those features. The input may also include aspects of patent figures, acronyms, and other aspects of a patent disclosure. The user input may be used to create an application data object, which may then be used to create components of a patent including patent specification components and patent figures such as diagrams and flow charts. The generated components may be combined with templates to generate patent documents. An automated patent preparation system may therefore be used to reduce the time and cost associated with patent preparation. The system may also combine text ad drawings from a library of background or client specific information. The drawings may be stored in the form of images, diagrams, or logical trees representing the structure of the drawings.

In one embodiment, a method may include identifying a plurality of features of an invention, identifying a plurality of system components, identifying a correspondence between each of the plurality of features of the invention and a system component of the plurality of system components, and identifying a patent application data object, wherein the patent application data object is based at least in part on the plurality of features of the invention and the correspondence between each of the plurality of features of the invention and the system component of the plurality of system components.

In one embodiment, a non-transitory computer-readable medium may include instructions operable to cause a processor to identify a plurality of features of an invention, identify a plurality of system components, identify a correspondence between each of the plurality of features of the invention and a system component of the plurality of system components, and identify a patent application data object, wherein the patent application data object is based at least in part on the plurality of features of the invention and the correspondence between each of the plurality of features of the invention and the system component of the plurality of system components.

In one embodiment, an apparatus may include a processor, memory in electronic communication with the processor, and instructions stored in the memory. The instructions may be operable to cause the processor to identify a plurality of features of an invention, identify a plurality of system components, identify a correspondence between each of the plurality of features of the invention and a system component of the plurality of system components, and identify a patent application data object, wherein the patent application data object is based at least in part on the plurality of features of the invention and the correspondence between each of the plurality of features of the invention and the system component of the plurality of system components.

In one embodiment, an apparatus may include means for identifying a plurality of features of an invention, means for identifying a plurality of system components, means for identifying a correspondence between each of the plurality of features of the invention and a system component of the plurality of system components, and means for identifying a patent application data object, wherein the patent application data object is based at least in part on the plurality of features of the invention and the correspondence between each of the plurality of features of the invention and the system component of the plurality of system components.

Some examples of the method, non-transitory computer-readable medium, and apparatus described above may further include processes, features, means, or instructions for identifying a tree structure for the plurality of features of the invention, wherein the patent application data object may be identified based at least in part on the tree structure. In some examples of the method, non-transitory computer-readable medium, and apparatus described above, the plurality of features of the invention comprise claim features, background details, invention details, enabling details, invention embodiment, invention components, method steps, or any combination thereof.

Some examples of the method, non-transitory computer-readable medium, and apparatus described above may further include processes, features, means, or instructions for identifying a first subset of the plurality of features of the invention as independent claim features, and a second subset of the plurality of features of the invention as dependent claim features. Some examples of the method, non-transitory computer-readable medium, and apparatus described above may further include processes, features, means, or instructions for identifying a third subset of the plurality of features of the invention as non-claim features.

Some examples of the method, non-transitory computer-readable medium, and apparatus described above may further include processes, features, means, or instructions for generating a claims section or a summary section of a patent application document based on the first subset and the second subset. Some examples of the method, non-transitory computer-readable medium, and apparatus described above may further include processes, features, means, or instructions for generating a detailed description section of a patent application document based on the first subset, the second subset and the third subset.

Some examples of the method, non-transitory computer-readable medium, and apparatus described above may further include processes, features, means, or instructions for reading one or more invention feature input fields of a user interface, wherein the plurality of features of the invention may be identified based at least in part on the reading the invention feature input fields of the user interface.

In some examples of the method, non-transitory computer-readable medium, and apparatus described above, the user interface comprises a plurality of input sections, the plurality of input sections comprising an application data input section, a feature input section, a figure input section, an acronym input section, or any combination thereof. In some examples of the method, non-transitory computer-readable medium, and apparatus described above, the feature input section and the figure input section each comprise a nested tree structure of display document objects. In some examples of the method, non-transitory computer-readable medium, and apparatus described above, the feature input section comprises one or more fields for associating the plurality of features of the invention and a system component of the plurality of system components. In some examples of the method, non-transitory computer-readable medium, and apparatus described above, the user interface comprises a drag-and-drop function for manipulating a nested tree structure of the plurality of features of the invention, a figure of the invention, or both. In some examples of the method, non-transitory computer-readable medium, and apparatus described above, the user interface comprises an editing function for editing text of the plurality of features of the invention, a figure of the invention, or both. In some examples of the method, non-transitory computer-readable medium, and apparatus described above, the user interface comprises a structure editing function for manipulating a nested tree structure of the plurality of features of the invention, a figure of the invention, or both. In some examples of the method, non-transitory computer-readable medium, and apparatus described above, the structure editing function may be based at least in part on association between arrow buttons on a user keyboard and structure manipulation subroutines for the nested tree structure.

Some examples of the method, non-transitory computer-readable medium, and apparatus described above may further include processes, features, means, or instructions for identifying an in invalid input based on reading one or more invention feature input fields. Some examples of the method, non-transitory computer-readable medium, and apparatus described above may further include processes, features, means, or instructions for displaying a warning indication on the user interface based on the invalid input.

In some examples of the method, non-transitory computer-readable medium, and apparatus described above, the invalid input may be identified based at least in part on an information threshold, a missing input, a relationship between the one or more invention feature input fields, or any combination thereof. In some examples of the method, non-transitory computer-readable medium, and apparatus described above, the missing input comprises a missing system correspondence input for a feature of the plurality of features of an invention.

Some examples of the method, non-transitory computer-readable medium, and apparatus described above may further include processes, features, means, or instructions for displaying the plurality of features of the invention, the plurality of system components, the correspondence between each of the plurality of features of the invention and the system component of the plurality of system components, or any combination thereof on a user interface. In some examples of the method, non-transitory computer-readable medium, and apparatus described above, the user interface comprises a plurality of input sections, the plurality of input sections comprising an application data input section, a feature input section, a figure input section, an acronym input section, or any combination thereof.

Some examples of the method, non-transitory computer-readable medium, and apparatus described above may further include processes, features, means, or instructions for identifying a nested tree structure of display document objects based at least in part on a nested tree structure of the plurality of features of the invention, wherein the displaying may be based on the nested tree structure of display document objects. In some examples of the method, non-transitory computer-readable medium, and apparatus described above, the nested tree structure of display document objects comprises a hypertext markup language (HTML) structure, a markup language tree structure, a scalable vector graphics (SVG) structure, or any combination thereof.

Some examples of the method, non-transitory computer-readable medium, and apparatus described above may further include processes, features, means, or instructions for identifying a nested tree structure of display document objects based at least in part on a nested tree structure of figures of the invention.

Some examples of the method, non-transitory computer-readable medium, and apparatus described above may further include processes, features, means, or instructions for determining whether a feature of the plurality of features of the invention may be a claim feature, a device component, a method step, a discussion feature, a background feature, an enabling detail, a non-claim feature, a component relationship feature, or any combination thereof. In some examples of the method, non-transitory computer-readable medium, and apparatus described above, the determination may be based at least in part on a feature category indication of a user interface.

Some examples of the method, non-transitory computer-readable medium, and apparatus described above may further include processes, features, means, or instructions for identifying a plurality of claims, wherein the each of the plurality of claims comprises at least one of the plurality of features of the invention and wherein the patent application data object may be identified based at least in part on the plurality of claims.

Some examples of the method, non-transitory computer-readable medium, and apparatus described above may further include processes, features, means, or instructions for identifying a nested tree structure for the plurality of claims, wherein the nested tree structure may be based at least in part on a dependency relationship between individual claims of the plurality of claims.

Some examples of the method, non-transitory computer-readable medium, and apparatus described above may further include processes, features, means, or instructions for reading one or more invention feature input fields, wherein the plurality of claims of the invention may be identified based at least in part on the reading.

Some examples of the method, non-transitory computer-readable medium, and apparatus described above may further include processes, features, means, or instructions for identifying a plurality of claim types for each of the plurality of claims, wherein the plurality of claim types comprises a method claim type, a means plus function claim type, a computer readable medium claim type, a processor function claim type, a device claim type, a system claim type, a chemical composition claim type, a business method claim type, an apparatus claim type, or any combination thereof.

Some examples of the method, non-transitory computer-readable medium, and apparatus described above may further include processes, features, means, or instructions for identifying at least one patent figure, wherein the patent application data object may be identified based at least in part on the at least one patent figure.

Some examples of the method, non-transitory computer-readable medium, and apparatus described above may further include processes, features, means, or instructions for identifying a nested tree structure for the at least one patent figure, wherein the nested tree structure comprises a set of relationships among a plurality of method steps, a plurality of figure components, or both. In some examples of the method, non-transitory computer-readable medium, and apparatus described above, the at least one figure comprises a flowchart figure.

Some examples of the method, non-transitory computer-readable medium, and apparatus described above may further include processes, features, means, or instructions for identifying at least one method step based at least in part on the plurality of features of the invention, wherein the flowchart figure comprises the method step.

Some examples of the method, non-transitory computer-readable medium, and apparatus described above may further include processes, features, means, or instructions for identifying a system component for the at least one method step. In some examples of the method, non-transitory computer-readable medium, and apparatus described above, the system component for the at least one method step may be based at least in part on the correspondence between each of the plurality of features of the invention and the system component of the plurality of system components. In some examples of the method, non-transitory computer-readable medium, and apparatus described above, the at least one figure comprises a system diagram figure.

Some examples of the method, non-transitory computer-readable medium, and apparatus described above may further include processes, features, means, or instructions for identifying at least one figure component, wherein the system diagram figure comprises the at least one figure component.

Some examples of the method, non-transitory computer-readable medium, and apparatus described above may further include processes, features, means, or instructions for identifying a correspondence between the at least one figure component and a subset of the plurality of features of the invention based at least in part on the correspondence between each of the plurality of features of the invention and the system component of the plurality of system components. In some examples of the method, non-transitory computer-readable medium, and apparatus described above, the at least one figure comprises size information, location information, numbering information, shape information, stencil information, component relationship information or any combination thereof.

Some examples of the method, non-transitory computer-readable medium, and apparatus described above may further include processes, features, means, or instructions for identifying one or more acronym objects, wherein the patent application data object includes the one or more acronym objects. In some examples of the method, non-transitory computer-readable medium, and apparatus described above, the one or more acronym objects comprises a short version and a long version, wherein the short version comprises a subset of letters of the long version.

Some examples of the method, non-transitory computer-readable medium, and apparatus described above may further include processes, features, means, or instructions for transmitting the patent application data object to a database server. Some examples of the method, non-transitory computer-readable medium, and apparatus described above may further include processes, features, means, or instructions for receiving a verification from the database server in response to the transmission.

Some examples of the method, non-transitory computer-readable medium, and apparatus described above may further include processes, features, means, or instructions for saving the patent application data object in a database based at least in part on client information, a docket number, a patent identifier, or any combination thereof.

Some examples of the method, non-transitory computer-readable medium, and apparatus described above may further include processes, features, means, or instructions for identifying an indication comprising a printing indication, a save indication, a user modification, a timer, or any combination thereof from a user interface, wherein the patent application data object may be transmitted to the database server based at least in part on the indication. Some examples of the method, non-transitory computer-readable medium, and apparatus described above may further include processes, features, means, or instructions for receiving the patent application data object from a database server.

Some examples of the method, non-transitory computer-readable medium, and apparatus described above may further include processes, features, means, or instructions for transmitting client information, a docket number, a patent identifier, or any combination thereof to the database server, wherein the patent application data object may be received in response to the transmission. In some examples of the method, non-transitory computer-readable medium, and apparatus described above, the patent application data object comprises a JSON object, a JavaScript data object, an object oriented programming data object, a nodeJS data object, an extensible markup language (XML) object, an SQL data object, a graph database object, a relational database object, or any combination thereof.

Some examples of the method, non-transitory computer-readable medium, and apparatus described above may further include processes, features, means, or instructions for transmitting the patent application data object to a document generation server. Some examples of the method, non-transitory computer-readable medium, and apparatus described above may further include processes, features, means, or instructions for receiving a drawings document from the document generation server in response to the transmission. In some examples of the method, non-transitory computer-readable medium, and apparatus described above, the drawings document comprises a Microsoft Visio document, an image document, a portable document format (PDF) document, an SVG document, a diagram document or any combination thereof.

Some examples of the method, non-transitory computer-readable medium, and apparatus described above may further include processes, features, means, or instructions for receiving a document link from the document generation server in response to the transmission. Some examples of the method, non-transitory computer-readable medium, and apparatus described above may further include processes, features, means, or instructions for transmitting a download request to the document generation server, wherein the drawings document may be received based on the download request.

Some examples of the method, non-transitory computer-readable medium, and apparatus described above may further include processes, features, means, or instructions for receiving a specification document from the document generation server. In some examples of the method, non-transitory computer-readable medium, and apparatus described above, the specification document comprises a Microsoft Word document, an open office XML document, a PDF document, a text document, or any combination thereof.

Some examples of the method, non-transitory computer-readable medium, and apparatus described above may further include processes, features, means, or instructions for receiving a document link from the document generation server in response to the transmission. Some examples of the method, non-transitory computer-readable medium, and apparatus described above may further include processes, features, means, or instructions for transmitting a download request to the document generation server, wherein the specification document may be received based on the download request.

Some examples of the method, non-transitory computer-readable medium, and apparatus described above may further include processes, features, means, or instructions for performing a natural language processing analysis on the plurality of features of the invention. In some examples of the method, non-transitory computer-readable medium, and apparatus described above, the correspondence between each of the plurality of features of the invention and a system component of the plurality of system components may be identified based at least in part on the natural language processing analysis.

Some examples of the method, non-transitory computer-readable medium, and apparatus described above may further include processes, features, means, or instructions for modifying at least one feature of the plurality of features of the invention according to a set of grammatical rules based at least in part on the natural language processing analysis, wherein the patent application data object comprises the modified at least one feature. In some examples of the method, non-transitory computer-readable medium, and apparatus described above, the set of grammatical rules comprises a list of specified grammatical constructions and a set of generic grammatical rules.

Some examples of the method, non-transitory computer-readable medium, and apparatus described above may further include processes, features, means, or instructions for identifying a technology tag, wherein the patent application data object comprises the technology tag.

Some examples of the method, non-transitory computer-readable medium, and apparatus described above may further include processes, features, means, or instructions for receiving text from a database based at least in part on the technology tag. In some examples of the method, non-transitory computer-readable medium, and apparatus described above, the plurality of features of the invention may be based at least in part on the text received from the database.

Some examples of the method, non-transitory computer-readable medium, and apparatus described above may further include processes, features, means, or instructions for transmitting text to a database based at least in part on the technology tag. Some examples of the method, non-transitory computer-readable medium, and apparatus described above may further include processes, features, means, or instructions for receiving a figure object from a data base based at least in part on the technology tag. In some examples of the method, non-transitory computer-readable medium, and apparatus described above, the patent application data object comprises the figure object. In some examples of the method, non-transitory computer-readable medium, and apparatus described above, the figure object comprises a plurality of component objects organized according to a nested tree structure.

Some examples of the method, non-transitory computer-readable medium, and apparatus described above may further include processes, features, means, or instructions for transmitting a figure object to a database server based at least in part on the technology tag. Some examples of the method, non-transitory computer-readable medium, and apparatus described above may further include processes, features, means, or instructions for identifying a text input, wherein the plurality of features of an invention may be identified based at least in part on the text input.

Some examples of the method, non-transitory computer-readable medium, and apparatus described above may further include processes, features, means, or instructions for performing an automatic textual analysis comprising a natural language processing analysis, a punctuation analysis, a grammatical analysis or any combination thereof on the text input, wherein the plurality of features of the invention may be identified based at least in part on the automatic textual analysis.

In some examples of the method, non-transitory computer-readable medium, and apparatus described above, the text input may be identified based on a user selected text document, pasted text input, an email input, a web based communication, or any combination thereof.

Some examples of the method, non-transitory computer-readable medium, and apparatus described above may further include processes, features, means, or instructions for generating text for an application section of a patent application based at least in part on the application data object, wherein the application section comprises a claims section, a summary section, a background section, a references section, a brief description section, a detailed description section, a field of the invention section, a title section, an abstract section, or any combination thereof. In some examples of the method, non-transitory computer-readable medium, and apparatus described above, the text for the application section comprises XML, markup, plain text, text markup, or any combination thereof. In some examples of the method, non-transitory computer-readable medium, and apparatus described above, the text for the application section comprises formatting information, numbering information, list information, or any combination thereof. In some examples of the method, non-transitory computer-readable medium, and apparatus described above, the text for the application section comprises dynamic fields, sequential numbering fields, reference fields corresponding to figure numbers, dynamically updating claim numbers, reference fields corresponding to claim dependencies, or any combination thereof. In some examples of the method, non-transitory computer-readable medium, and apparatus described above, the text for the claims section may be generated based at least in part on a nested tree structure of the plurality of features of the invention.

Some examples of the method, non-transitory computer-readable medium, and apparatus described above may further include processes, features, means, or instructions for identifying a claim form for each of a set of claim types of the patent application data object, wherein the text for the claims section may be generated based at least in part on the claim form for each of the set of claim types. In some examples of the method, non-transitory computer-readable medium, and apparatus described above, the claim form for each of the set of claim types comprises a feature grammatical form, a preamble form, or both. In some examples of the method, non-transitory computer-readable medium, and apparatus described above, the summary section comprises a plurality of repetitions for a first subset of the plurality of features of the invention and a single repetition for a second subset of the plurality of features of the invention based at least in part on the first subset being independent claim features and the second subset being dependent claim features. In some examples of the method, non-transitory computer-readable medium, and apparatus described above, the detailed description section comprises at least one description of a block diagram figure.

Some examples of the method, non-transitory computer-readable medium, and apparatus described above may further include processes, features, means, or instructions for generating a description for each of a set of components of a figure of the patent application data object based at least in part on a nested tree structure of the components within the patent application data object, wherein the at least one description of the block diagram figure comprises the generated description.

Some examples of the method, non-transitory computer-readable medium, and apparatus described above may further include processes, features, means, or instructions for identifying a subset of the plurality of features of the invention based at least in part on the correspondence between each of the plurality of features of the invention and the system component of the plurality of system components, wherein the generated description may be based at least in part on the subset of the plurality of features of the invention.

Some examples of the method, non-transitory computer-readable medium, and apparatus described above may further include processes, features, means, or instructions for identifying at least on feature based at least in part on a technology tag or a component name of the application data object, wherein the generated description may be based at least in part on the at least one feature. In some examples of the method, non-transitory computer-readable medium, and apparatus described above, the generated description comprises a dynamic field indicating that a component described in the generated description corresponds to a description of a figure different from the block diagram figure. In some examples of the method, non-transitory computer-readable medium, and apparatus described above, the detailed description section comprises at least one description of a flowchart. In some examples of the method, non-transitory computer-readable medium, and apparatus described above, the at least one description of the flowchart includes a description of a plurality of steps based on the plurality of features of the invention or a set of steps of a figure object of the application data object.

Some examples of the method, non-transitory computer-readable medium, and apparatus described above may further include processes, features, means, or instructions for identifying a system component of the plurality of system components based at least in part on a correspondence between the system component a step of the plurality of steps in the application data object. Some examples of the method, non-transitory computer-readable medium, and apparatus described above may further include processes, features, means, or instructions for generating component reference text based on the identified system component, wherein the description of a plurality of steps comprises the component reference text.

Some examples of the method, non-transitory computer-readable medium, and apparatus described above may further include processes, features, means, or instructions for identifying a set of figures that include the identified system component, wherein the component reference text may be generated based at least in part on the set of figures.

Some examples of the method, non-transitory computer-readable medium, and apparatus described above may further include processes, features, means, or instructions for identifying a set of components or flowchart steps. Some examples of the method, non-transitory computer-readable medium, and apparatus described above may further include processes, features, means, or instructions for identifying a reference number for each of the set of components or flowchart steps. Some examples of the method, non-transitory computer-readable medium, and apparatus described above may further include processes, features, means, or instructions for inserting the reference number for each of the set of components or flowchart steps into the detailed description section.

Some examples of the method, non-transitory computer-readable medium, and apparatus described above may further include processes, features, means, or instructions for performing a search function on the detailed description section based on the set of components or flowchart steps, wherein inserting the reference number may be based on the search function.

Some examples of the method, non-transitory computer-readable medium, and apparatus described above may further include processes, features, means, or instructions for performing a tree search function on a figure of the patent application data object. Some examples of the method, non-transitory computer-readable medium, and apparatus described above may further include processes, features, means, or instructions for identifying a count of the set of components or flowchart steps based at least in part on the tree search function, wherein the reference number for each of the set of components or flowchart steps may be based at least in part on the count. In some examples of the method, non-transitory computer-readable medium, and apparatus described above, the brief description section comprises reference fields that correspond to figure numbers located in the detailed description section.

Some examples of the method, non-transitory computer-readable medium, and apparatus described above may further include processes, features, means, or instructions for determining whether a feature of the plurality of features comprises an active feature, a passive feature, a substep, a device component, a component detail, or any combination thereof based on a natural language processing analysis of the feature, wherein the text for the application section may be based on the determination.

Some examples of the method, non-transitory computer-readable medium, and apparatus described above may further include processes, features, means, or instructions for performing a search and replace function for a set of acronyms of the application data object, wherein the text for the application section may be based on the search and replace function. In some examples of the method, non-transitory computer-readable medium, and apparatus described above, the brief description section comprises a listing of figures based at least in part on a set of figures of the application data object. In some examples of the method, non-transitory computer-readable medium, and apparatus described above, the listing of figures includes abbreviated ranges of figures based at least in part on one or more subsets of the set of figures having substantially similar figure names. In some examples of the method, non-transitory computer-readable medium, and apparatus described above, the brief description section comprises text based on an invention description field of the patent application data object.

Some examples of the method, non-transitory computer-readable medium, and apparatus described above may further include processes, features, means, or instructions for performing a grammatical transformation on at least one of the plurality of features of the invention, wherein the text for the application section may be based at least in part on the grammatical transformation.

Some examples of the method, non-transitory computer-readable medium, and apparatus described above may further include processes, features, means, or instructions for inserting the text for the application section into a patent application template to form a patent application document. In some examples of the method, non-transitory computer-readable medium, and apparatus described above, the patent application data object comprises an indication of the patent application template, wherein inserting the text for the claims section may be based at least in part on the indication of the patent application template.

Some examples of the method, non-transitory computer-readable medium, and apparatus described above may further include processes, features, means, or instructions for deleting excess markup from the patent application document. Some examples of the method, non-transitory computer-readable medium, and apparatus described above may further include processes, features, means, or instructions for identifying the excess markup based at least in part on a set of markup rules.

Some examples of the method, non-transitory computer-readable medium, and apparatus described above may further include processes, features, means, or instructions for deleting excess markup from the patent application template, wherein the patent application document may be based on deleting the excess markup. Some examples of the method, non-transitory computer-readable medium, and apparatus described above may further include processes, features, means, or instructions for identifying the excess markup based at least in part on a set of markup rules.

Some examples of the method, non-transitory computer-readable medium, and apparatus described above may further include processes, features, means, or instructions for identifying a one or more search terms within the patent application template, wherein the text for the application section may be inserted based on the identified one or more search terms. Some examples of the method, non-transitory computer-readable medium, and apparatus described above may further include processes, features, means, or instructions for identifying a bookmark element within the patent application template, wherein the text for the application section may be inserted based on the identified bookmark.

Some examples of the method, non-transitory computer-readable medium, and apparatus described above may further include processes, features, means, or instructions for identifying one or more empty run elements within the patent application template. Some examples of the method, non-transitory computer-readable medium, and apparatus described above may further include processes, features, means, or instructions for merging the one or more empty runs. Some examples of the method, non-transitory computer-readable medium, and apparatus described above may further include processes, features, means, or instructions for identifying one or more text runs. Some examples of the method, non-transitory computer-readable medium, and apparatus described above may further include processes, features, means, or instructions for generating one or more text run markup sections based on the text runs. Some examples of the method, non-transitory computer-readable medium, and apparatus described above may further include processes, features, means, or instructions for identifying a set of paragraph properties. Some examples of the method, non-transitory computer-readable medium, and apparatus described above may further include processes, features, means, or instructions for generating a paragraph markup section based at least in part on the one or more text run markup sections and the set of paragraph properties, wherein the text for the application section comprises the paragraph markup section.

Some examples of the method, non-transitory computer-readable medium, and apparatus described above may further include processes, features, means, or instructions for inserting a paragraph ending markup at the beginning of the text for the application section and a paragraph beginning markup at the end of the application section. Some examples of the method, non-transitory computer-readable medium, and apparatus described above may further include processes, features, means, or instructions for transforming a gerund form of a feature of the plurality of features of the invention to an infinitive form of the feature, wherein the text of the application section may be based at least in part on the transformation.

Some examples of the method, non-transitory computer-readable medium, and apparatus described above may further include processes, features, means, or instructions for transforming an infinitive form of a feature of the plurality of features of the invention to a gerund form of the feature, wherein the text of the application section may be based at least in part on the transformation.

Some examples of the method, non-transitory computer-readable medium, and apparatus described above may further include processes, features, means, or instructions for identifying a first letter of a component of the plurality of system components. Some examples of the method, non-transitory computer-readable medium, and apparatus described above may further include processes, features, means, or instructions for identifying an article based on the first letter. Some examples of the method, non-transitory computer-readable medium, and apparatus described above may further include processes, features, means, or instructions for inserting the article into the text of the application section.

Some examples of the method, non-transitory computer-readable medium, and apparatus described above may further include processes, features, means, or instructions for identifying a first letter of a sentence. Some examples of the method, non-transitory computer-readable medium, and apparatus described above may further include processes, features, means, or instructions for replacing the first letter of a sentence with a capitalized version of the first letter of the sentence, wherein the text of the application section may be based at least in part on the replacement.

Some examples of the method, non-transitory computer-readable medium, and apparatus described above may further include processes, features, means, or instructions for identifying a list of elements. Some examples of the method, non-transitory computer-readable medium, and apparatus described above may further include processes, features, means, or instructions for identifying the last element of the list of elements, the penultimate element of the list of elements, or both. Some examples of the method, non-transitory computer-readable medium, and apparatus described above may further include processes, features, means, or instructions for appending a separator to one or more elements of the list of elements based at least in part on the identified last element of the list of elements, the identified penultimate element of the list of elements, or both. Some examples of the method, non-transitory computer-readable medium, and apparatus described above may further include processes, features, means, or instructions for generating a text list of the list of elements based at least in part on the list of elements and the appended separators to the one or more elements, wherein the text of the application section may be based at least in part on the text list.

Some examples of the method, non-transitory computer-readable medium, and apparatus described above may further include processes, features, means, or instructions for identifying a file name for a patent application document based at least in part on the patent application data object. Some examples of the method, non-transitory computer-readable medium, and apparatus described above may further include processes, features, means, or instructions for generating the patent application document based at least in part on the patent application data object. Some examples of the method, non-transitory computer-readable medium, and apparatus described above may further include processes, features, means, or instructions for saving the patent application document based at least in part on the file name.

Some examples of the method, non-transitory computer-readable medium, and apparatus described above may further include processes, features, means, or instructions for transmitting a document link to the patent application document based on the file name. Some examples of the method, non-transitory computer-readable medium, and apparatus described above may further include processes, features, means, or instructions for generating a drawings document based at least in part on the patent application data object.

Some examples of the method, non-transitory computer-readable medium, and apparatus described above may further include processes, features, means, or instructions for transmitting the drawings document to a browser based application. In some examples of the method, non-transitory computer-readable medium, and apparatus described above, the drawings document comprises a Microsoft Visio document, a diagram document, an SVG document, an image document, a PDF document, or any combination thereof.

Some examples of the method, non-transitory computer-readable medium, and apparatus described above may further include processes, features, means, or instructions for generating at least one flowchart figure, at least one diagram figure, or both based on the patent application data object, wherein the drawings document comprises the at least on flowchart figure, the at least one diagram figure, or both. In some examples of the method, non-transitory computer-readable medium, and apparatus described above, the at least one flowchart figure, the at least one diagram figure, or both comprise an XML object that includes a plurality of XML shape objects.

Some examples of the method, non-transitory computer-readable medium, and apparatus described above may further include processes, features, means, or instructions for generating at least one step object, wherein the at least one flowchart figure comprises the at least one step object. In some examples of the method, non-transitory computer-readable medium, and apparatus described above, the step object comprises a rectangular shape, a diamond shape, a circular shape, an oval shape, a rectangular shape with rounded corners, or any combination thereof. In some examples of the method, non-transitory computer-readable medium, and apparatus described above, the step object comprises text based at least in part on one of the plurality of features of the invention.

Some examples of the method, non-transitory computer-readable medium, and apparatus described above may further include processes, features, means, or instructions for performing a capitalization function on the text of the step object. Some examples of the method, non-transitory computer-readable medium, and apparatus described above may further include processes, features, means, or instructions for performing a text simplification function on the text of the step object. In some examples of the method, non-transitory computer-readable medium, and apparatus described above, the step object comprises a lead line object. In some examples of the method, non-transitory computer-readable medium, and apparatus described above, the lead line object comprises a Non-uniform rational basis spline (NURBS) object. In some examples of the method, non-transitory computer-readable medium, and apparatus described above, the step object comprises an arrow object. In some examples of the method, non-transitory computer-readable medium, and apparatus described above, the step object comprises a reference number. In some examples of the method, non-transitory computer-readable medium, and apparatus described above, the reference number comprises a dynamic page reference.

Some examples of the method, non-transitory computer-readable medium, and apparatus described above may further include processes, features, means, or instructions for identifying a number of steps of the at least one flowchart figure, wherein the reference number may be based on the number of steps.

Some examples of the method, non-transitory computer-readable medium, and apparatus described above may further include processes, features, means, or instructions for identifying a standard distance between reference numbers and step objects. Some examples of the method, non-transitory computer-readable medium, and apparatus described above may further include processes, features, means, or instructions for determining a location of the step object. Some examples of the method, non-transitory computer-readable medium, and apparatus described above may further include processes, features, means, or instructions for determining a location of the reference number based at least in part on the location of the step object and the standard distance. In some examples of the method, non-transitory computer-readable medium, and apparatus described above, the at least one flowchart figure comprises a plurality of arrow objects, wherein each of the arrow objects may have a location between two step objects.

Some examples of the method, non-transitory computer-readable medium, and apparatus described above may further include processes, features, means, or instructions for identifying a location of a step object. Some examples of the method, non-transitory computer-readable medium, and apparatus described above may further include processes, features, means, or instructions for identifying a standard distance between step objects and arrow objects. Some examples of the method, non-transitory computer-readable medium, and apparatus described above may further include processes, features, means, or instructions for determining the location of an arrow object of the plurality of arrow objects based at least in part on the location of the step object and the standard distance.

Some examples of the method, non-transitory computer-readable medium, and apparatus described above may further include processes, features, means, or instructions for identifying a size of a first step object from a set of step objects of the at least one flowchart figure, wherein the size of the first step object may be based at least in part on a length of text of the first step object. Some examples of the method, non-transitory computer-readable medium, and apparatus described above may further include processes, features, means, or instructions for identifying a location of the first step object. Some examples of the method, non-transitory computer-readable medium, and apparatus described above may further include processes, features, means, or instructions for determining a location of a second step object based at least in part on size of the first step object and the location of the first step object or based on a size of the second step object and the location of the first step object.

Some examples of the method, non-transitory computer-readable medium, and apparatus described above may further include processes, features, means, or instructions for identifying a standard gap distance, wherein the location of the second step object may be determined based at least in part on the standard gap distance.

Some examples of the method, non-transitory computer-readable medium, and apparatus described above may further include processes, features, means, or instructions for determining a size for each step object of a set of step objects of the at least one flowchart figure. Some examples of the method, non-transitory computer-readable medium, and apparatus described above may further include processes, features, means, or instructions for determining a total size based at least in part on the size for each step object. Some examples of the method, non-transitory computer-readable medium, and apparatus described above may further include processes, features, means, or instructions for determining a location of the at least one flowchart figure based on the total size. Some examples of the method, non-transitory computer-readable medium, and apparatus described above may further include processes, features, means, or instructions for determining a location of each step object of the at least one flowchart figure based on the location of the at least one flowchart figure.

Some examples of the method, non-transitory computer-readable medium, and apparatus described above may further include processes, features, means, or instructions for performing a depth first search or a breadth first search on the set of step objects of the at least one flowchart figure, wherein the total size may be based at least in part on the depth first search or the breadth first search. In some examples of the method, non-transitory computer-readable medium, and apparatus described above, the at least one flowchart figure comprises a NURBS object.

Some examples of the method, non-transitory computer-readable medium, and apparatus described above may further include processes, features, means, or instructions for identifying a master shape. Some examples of the method, non-transitory computer-readable medium, and apparatus described above may further include processes, features, means, or instructions for modifying one or more aspects of the master shape based at least in part on the patent application data object, wherein the at least one flowchart figure, the at least one diagram figure, or both may be based on the modified master shape. In some examples of the method, non-transitory computer-readable medium, and apparatus described above, the master shape comprises an arrow master shape, a lead line master shape, a device master shape, a bus master shape, an electrical component master shape, a label master shape, or any combination thereof. In some examples of the method, non-transitory computer-readable medium, and apparatus described above, the at least one diagram figure comprises one or more component objects. In some examples of the method, non-transitory computer-readable medium, and apparatus described above, each of the one or more component objects may be based at least in part on a system object of the plurality of system objects.

Some examples of the method, non-transitory computer-readable medium, and apparatus described above may further include processes, features, means, or instructions for determining a size for each of the one or more component objects based at least in part on a depth first search of a nested set of component objects within the one or more components. Some examples of the method, non-transitory computer-readable medium, and apparatus described above may further include processes, features, means, or instructions for determining a total size of the at least one diagram figure based at least in part on the identified size for each of the one or more component objects. Some examples of the method, non-transitory computer-readable medium, and apparatus described above may further include processes, features, means, or instructions for determining a location for the at least one diagram figure based on the total size. Some examples of the method, non-transitory computer-readable medium, and apparatus described above may further include processes, features, means, or instructions for determining a location for each of the one or more component objects based at least in part on a breadth first search of the one or more component objects. In some examples of the method, non-transitory computer-readable medium, and apparatus described above, the location for each of the one or more component objects may be based on a layout direction variable, wherein the layout direction variable comprises a horizontal value, a vertical value, a column value, a row value, a circular value, or any combination thereof.

Some examples of the method, non-transitory computer-readable medium, and apparatus described above may further include processes, features, means, or instructions for identifying a nesting depth of a component object. Some examples of the method, non-transitory computer-readable medium, and apparatus described above may further include processes, features, means, or instructions for determining a value of the layout direction variable based at least in part on the nesting depth. In some examples of the method, non-transitory computer-readable medium, and apparatus described above, each of the one or more component objects comprises a component name. In some examples of the method, non-transitory computer-readable medium, and apparatus described above, each of the one or more component objects comprises a component reference number. In some examples of the method, non-transitory computer-readable medium, and apparatus described above, the component reference number may be the same as a component reference number of a corresponding component object in a specification document. In some examples of the method, non-transitory computer-readable medium, and apparatus described above, the component reference number comprises a dynamic field corresponding to a page number of the at least one diagram figure. In some examples of the method, non-transitory computer-readable medium, and apparatus described above, the component reference number comprises an underline format indicator, a lead line object, or both. In some examples of the method, non-transitory computer-readable medium, and apparatus described above, the at least one diagram object comprises a plurality of custom hardware component shapes and a plurality of block shapes.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for patent preparation, comprising:
identifying a set of invention features;
generating a first tree structure, wherein one or more nodes of the first tree structure correspond to a first subset of the set of invention features;
generating a second tree structure, wherein one or more nodes of the second tree structure correspond to a second subset of the set of invention features; and
automatically generating one or more patent application documents based at least in part on the first tree structure and the second tree structure.

2. The method of claim 1, wherein:
each invention feature in the first subset comprises an attribute identifying a node of the one or more nodes of the first tree, and each invention feature in the second subset comprises an attribute identifying a node of the one or more nodes of the second tree.

3. The method of claim 1, wherein:
at least a portion of the second tree structure is automatically generated based on the first tree structure.

4. The method of claim 1, wherein:
the first tree structure comprises a topic hierarchy and the second tree structure comprises a claim hierarchy.

5. The method of claim 4, further comprising:
generating at least a portion of the second tree structure by assigning sibling nodes of the topic hierarchy as sibling features of a claim, and by assigning a dependency of the claim based on a parent node of the sibling nodes.

6. The method of claim 1, wherein:
the first tree structure comprises a claim hierarchy and the second tree structure comprises a figure hierarchy.

7. The method of claim 6, wherein:
at least one figure node of the figure hierarchy comprises a flowchart corresponding to a claim of the claim hierarchy, and wherein each feature of the claim corresponds to a step in the flowchart.

8. The method of claim 7, wherein:
each feature of a parent claim in the claim hierarchy corresponds to a step in the flowchart.

9. The method of claim 1, further comprising:
performing a first natural language processing function on a feature of the set of invention features based on a correspondence with the first tree structure; and
performing a second natural language processing function on the feature based on a correspondence with the second tree structure.

10. The method of claim 1, wherein:
the set of invention features are represented as an array object, and wherein the first tree structure and the second tree structure are represented as non-array objects.

11. The method of claim 1, further comprising:
importing a claim set, wherein the set of invention features is identified based on the imported claim set.

12. An apparatus for computer based patent preparation, comprising: a processor and a memory storing instructions and in electronic communication with the processor, the processor being configured to execute the instructions to:
identify a set of invention features;
generate a first tree structure, wherein one or more nodes of the first tree structure correspond to a first subset of the set of invention features;
generate a second tree structure, wherein one or more nodes of the second tree structure correspond to a second subset of the set of invention features; and
automatically generate one or more patent application documents based at least in part on the first tree structure and the second tree structure.

13. The apparatus of claim 12, wherein:
each invention feature in the first subset comprises an attribute identifying a node of the one or more nodes of the first tree, and each invention feature in the second subset comprises an attribute identifying a node of the one or more nodes of the second tree.

14. The apparatus of claim 12, wherein:
at least a portion of the second tree structure is automatically generated based on the first tree structure.

15. The apparatus of claim 12, wherein:
the first tree structure comprises a topic hierarchy and the second tree structure comprises a claim hierarchy.

16. The apparatus of claim 15, the processor being further configured to execute the instructions to:
generate at least a portion of the second tree structure by assigning sibling nodes of the topic hierarchy as sibling features of a claim, and by assigning a dependency of the claim based on a parent node of the sibling nodes.

17. The apparatus of claim 12, wherein:
the first tree structure comprises a claim hierarchy and the second tree structure comprises a figure hierarchy.

18. The apparatus of claim 17, wherein:
at least one figure node of the figure hierarchy comprises a flowchart corresponding to a claim of the claim hierarchy, and wherein each feature of the claim corresponds to a step in the flowchart.

19. The apparatus of claim 12, the processor being further configured to execute the instructions to:
perform a first natural language processing function on a feature of the set of invention features based on a correspondence with the first tree structure; and
perform a second natural language processing function on the feature based on a correspondence with the second tree structure.

20. A non-transitory computer readable medium storing code for computer based patent preparation, the code comprising instructions executable by a processor to:
identify a set of invention features;
generate a first tree structure, wherein one or more nodes of the first tree structure correspond to a first subset of the set of invention features;
generate a second tree structure, wherein one or more nodes of the second tree structure correspond to a second subset of the set of invention features; and
automatically generate one or more patent application documents based at least in part on the first tree structure and the second tree structure.
